(19) United States
(12) Patent Application Publication
(10) Pub. No.: US 2015/0195357 A1
(43) Pub. Date: Jul. 9, 2015

(54) ENHANCING ACTIVE LINK UTILIZATION IN SERIAL ATTACHED SCSI TOPOLOGIES

(71) Applicant: LSI Corporation, Lehigh Valley Campus 12L-304, PA (US)

(72) Inventors: Shankar T. More, Pune (IN); Vidyadhar C. Pinglikar, Pune (IN)

(73) Assignee: LSI Corporation, Lehigh Valley Campus 12L-304, PA (US)

(21) Appl. No.: 14/182,008

(22) Filed: Feb. 17, 2014

(30) Foreign Application Priority Data
Jan. 3, 2014 (IN) 24/CHE/2014

(51) Int. Cl. H04L 29/08; G06F 3/06; G06F 13/38

(52) U.S. Cl. CPC H04L 67/1097; G06F 13/385; G06F 3/061; G06F 3/0653; G06F 3/067; G06F 2213/0028

(57) ABSTRACT

Methods and systems are provided for enhanced link utilization in attached SCSI (SAS) topologies. A SAS expander may be configured to monitor link utilization within a SAS topology, and may manage connection requests received thereby based on the monitoring of link utilization. The monitoring may comprise determining availability of links for at least one node within the SAS topology with respect to other nodes in the SAS topology. This may be done based on pending connection requests, and/or responses thereto received by the SAS expander. It may also be done based on shared link utilization data. The managing may comprise determining for each received connection request when link unavailability in other nodes within the SAS topology prevents connectivity to a destination node corresponding to the connection request. When this situation occurs, the SAS expander may handle the connection request directly.

### CLAIM OF PRIORITY

This patent application claims the filing date benefit of and right of priority to Indian Provisional Patent Application No. 24/CHE/2014, which was filed on Jan. 3, 2014. The above stated application is hereby incorporated herein by reference in its entirety.

### FIELD OF INVENTION

Aspects of the present application relate to networking. More specifically, certain implementations of the present disclosure relate to enhancing active link utilization in serial attached SCSI (SAS) topologies.

### BACKGROUND

Existing methods and systems for utilizing links in various topologies, including SAS topologies, may be inefficient, and may result in under-utilization of links and reduction in performance. Further limitations and disadvantages of conventional and traditional approaches will become apparent to one of skill in the art, through comparison of such approaches with some aspects of the present method and apparatus set forth in the remainder of this disclosure with reference to the drawings.

### SUMMARY

Systems and/or methods are provided for enhancing active link utilization in serial attached SCSI (SAS) topologies, substantially as shown in and/or described in connection with at least one of the figures, as set forth more completely in the claims. In particular, a network device that is configured to provide an expander function within a serial attached SCSI (SAS) topology may monitor link utilization within the SAS topology, wherein the monitoring may comprise determining availability of links in other nodes in the SAS topology; and managing connection requests received by the expander function based on the monitoring of link utilization, wherein the managing comprises determining for each received connection request when link unavailability in the other nodes within the SAS topology prevents connectivity to a destination node corresponding to the connection request. These and other advantages, aspects and novel features of the present disclosure, as well as details of illustrated implementation(s) thereof, will be more fully understood from the following description and drawings.

### BRIEF DESCRIPTION OF THE DRAWINGS

FIG. 1 illustrates an example network incorporating a Serial Attached SCSI (SAS) based networking topology.

FIG. 2A illustrates an example link utilization scenario in a Serial Attached SCSI (SAS) based networking topology.

FIG. 2B illustrates an example use of a link utilization enhancement scheme in a Serial Attached SCSI (SAS) based networking topology.

FIGS. 3A and 3B illustrate an example use of a link utilization enhancement scheme in a Serial Attached SCSI (SAS) based networking topology, based on sharing of link related data.

FIG. 4 is a flowchart illustrating an example process for handling connection requests in a SAS topology incorporating use of enhanced link utilization.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “example” means serving as a non-limiting example, instance, or illustration. As utilized herein, the terms “for example” and “e.g.,” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

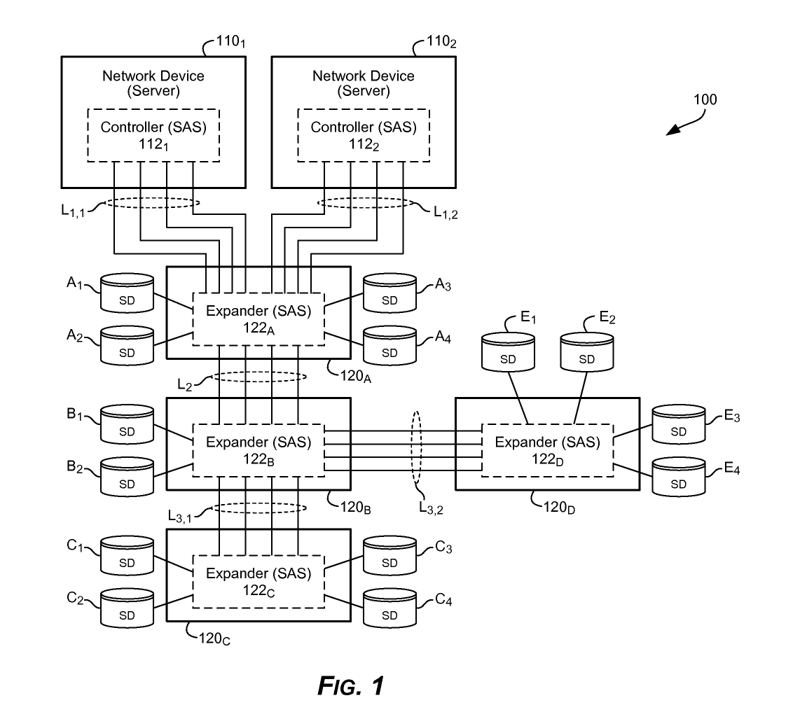

FIG. 1 illustrates an example network incorporating a Serial Attached SCSI (SAS) based networking topology. Referring to FIG. 1, there is shown a plurality of network devices 110₁ and 110₂ and 120_{A}-120_{D}.

Each of the network devices may comprise suitable circuitry for implementing various aspects of the present disclosure. For example, a network device, as used herein, may comprise suitable circuitry configured for performing or supporting various functions, operations, applications, and/or services. The functions, operations, applications, and/or services performed or supported by the network device may be run or controlled based on user instructions and/or pre-configured instructions. The network device may support communication of data, such as via wired and/or wireless connections, in accordance with one or more supported wireless and/or wired protocols or standards. Examples of network devices may comprise computers (e.g., servers, desktops, and laptops) and the like. The disclosure, however, is not limited to any particular type of network device.

The plurality of network devices 110₁ and 110₂ and 120_{A}-120_{D} may be part of a topology 100. The topology 100 may comprise a plurality of systems, devices, and/or components, for supporting interactions in accordance with various types of connections, interfaces, and/or protocols. For example, the topology 100 may be configured to support Serial Attached SCSI (SAS) based interactions (as such it may be referred hereinafter as SAS topology).

In some instances, the network devices 110₁ and 110₂ and 120_{A}-120_{D} may be configured provide different functions, such as in accordance with a particular topology implemented using the devices. For example, the network devices 110₁ and 110₂ may be utilized as ‘servers’ (and as such they may be referred hereinafter as the servers 110₁ and 110₂); whereas the network devices 110₁ and 110₂ and 120_{A}-120_{D} the may be utilized as ‘clients’ (and as such they may be referred hereinafter as the clients 120_{A}-120_{D}). In this regard, within the SAS topology 100, the servers 110₁ and 110₂ may be utilized to run SAS controller functions (e.g., SAS controllers 112₁ and 112₂, respectively), whereas the clients 120_{A}-120_{D} may be used to run SAS expander functions (e.g., SAS expanders 122_{A}-122_{D}, respectively), which may be utilized in providing connectivity within the SAS topology 100.

In addition to SAS controllers and SAS expanders, SAS topologies may also comprise such (other) components as SAS devices (SDs) (e.g., devices providing storage resources), and network links for providing connectivity between the network nodes (e.g., devices in which expanders and controllers are run). For example, the SAS topology 100 may also comprise SAS devices (SDs) A₁-A₄, B₁-B₂, C₁-C₄, and D₁-D₄, which may be attached to SAS expanders 122_{A}-122_{D}, respectively. The topology SAS may also comprise various links between its constituent components—e.g., links L_{1,1} and L_{1,2} between expander 122_{A} and controllers 112₁ and 112₂, respectively; links L₂ between expanders 122_{A} and 122_{B}; and links L_{3,1} and L_{3,2} between expander 122_{A} and expanders 122_{C} and 122_{D}, respectively. Nonetheless, the structure of the SAS topology 100 as shown in FIG. 1 is merely an illustrative, non-limiting example, and various implementations in accordance with the present disclosure are not limited to that particular structure and would apply in a similar manner to any SAS topology.

In SAS topologies, single and/or multiple SAS initiators may be connected to SAS devices (SDs) through a chain of SAS expanders, where the SAS expander link resources may be shared between multiple initiators in order to access the SAS drives in the underlying SAS topology. Accordingly, SAS expanders may be used to provide system connectivity and service delivery within SAS topology—e.g., facilitating connectivity to SDs attached to the SAS expanders (e.g., drives or other storage resources in the corresponding network devices), to other expanders, and to the SAS controllers.

In some instances, partial paths may be setup in SAS topologies. For example, a connection request (e.g., in the form of open access frame or ‘OAF’) may be sent, such as from a SAS device (SD), and may be forwarded by the expanders—i.e., from one expander to another, until it reaches a designated destination (e.g., a SAS controller). In doing so, corresponding links between the expanders in the path towards the destination may be used and reserved for that connection request. In some instances, however, an OAF may stop before reaching the destination. For example, when an OAF that is being forwarded reaches a node that lacks available links to the next node in the chain, the OAF may need to wait and arbitrate for the next level of path to become available. Thus, forwarding the connection request (OAF) would result in acquiring a partial path within the SAS topology all the way from the initiator node (e.g., the SD) to the expander that lacks available link. When that happens, the node (e.g., expander) in which the OAF is being arbitrated may generate arbitration-in-progress (AIP) responses, which would be sent by the expander in which the arbitration is being down (and forwarded by the remaining expanders in the partial path acquired for the OAF) to notify of the connection status. Further, the partial path acquired for handling the pending OAF request would remain idle (i.e., the links used to set it up all the way to the last expander remain in use), and may remain idle until the arbitration is resolved successfully—e.g., a link to next level, in the expander in which the arbitration is being done, becomes available (e.g., one of the links that were being used is freed, such as when another connection is terminated), or until some event occurs resulting in cessation of connection attempt—e.g., the arbitration is terminated (such as based on timer expiry) before acquiring link to the next node, or if a connection request with higher priority is received by any of the node in the partial path, resulting in dropping of the established partial path (or portions thereof) to free some links. In some instances, the partial path acquired by the OAF may comprise some shared path portions, which may be used for completion of equal or low priority connection requests and subsequent flow of input/output (TO) traffic from other end devices. Nonetheless, with existing systems, such low/equal priority connection requests have to wait on partial paths of these higher priority OAFs. Therefore, partial paths may cause undesirable inefficiencies in SAS topologies, particularly where they result in use of links that are unnecessarily taken simply to setup up a path all the way from the start point (the initiator) to the last node in the partial path (e.g., the last expander, in which arbitration is performed).

Accordingly, in various implementations in accordance with the present disclosure, SAS topologies may be enhanced, such as by localizing partial paths in a manner that may enable reducing idle partial path links in the SAS topology, thereby increasing the active link utilization for overall improvement in IO throughput of the SAS topology. In this regard, in a multi-initiator SAS topology with heavy IO in progress, localization of partial paths may help in significantly reducing the congestion at the upstream links and those links can be efficiently used for increasing the throughput of overall IO traffic in that topology.

In a particular implementation, an enhanced link utilization scheme may be utilized in a SAS scheme. For example, when a SAS expander receives an OAF, it may determine if there are any pending connection requests through that SAS expander. If so, the SAS expander may compare the received OAF with the pending connection requests. For example, the SAS expander may compare the destination SAS address in the received OAF with destination SAS addressees of all currently pending connection requests. If there is at least one pending connection with higher priority request in which the destination SAS address matches with the destination SAS address in the received OAF, and the SAS expander is currently receiving AIP responses for that pending connection request, the SAS expander would not forward the received OAF through to one of the available destinations. Rather, the SAS expander may generate and forward (send back) the AIP responses (on the incoming link of the received OAF), and may continue to do so for as long as the condition—i.e., reception of AIP responses for the matched pending connection request(s)—persists. This may be done because if the SAS expander is already receiving AIP responses for higher priority requests (for a destination SAS address), then any other new OAF requests for the same destination SAS address need not acquire and block the further available partial paths, and those partial paths should be made available for completing/forwarding other possible connection requests and IO traffic. Use of enhanced link utilization in SAS topologies is described in more detail in connection with the following figures.

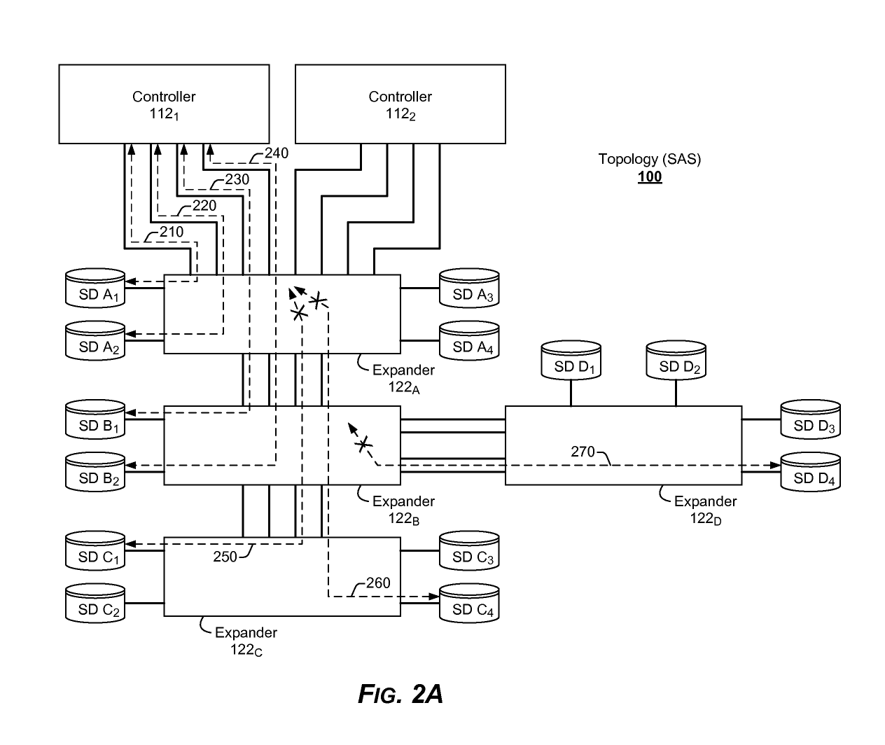

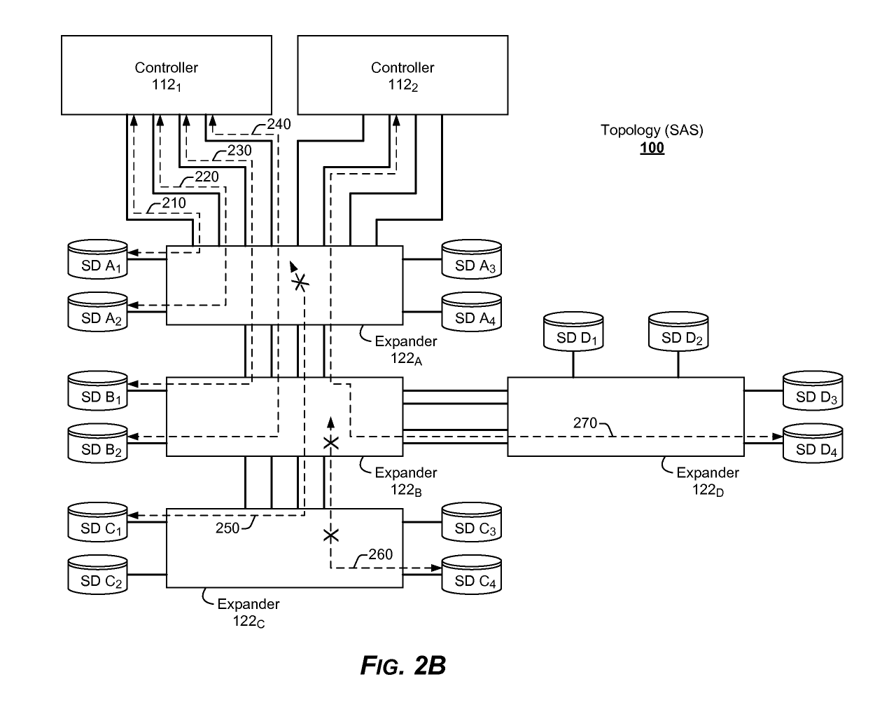

FIG. 2A illustrates an example link utilization scenario in a Serial Attached SCSI (SAS) based networking topology. Referring to FIG. 2A, there is shown topology 100 of FIG. 1. In particular, the controllers 112₁ and 112₂, the expanders 122_{A}-122_{D}, and the SAS devices A₁-A₄, B₁-B₂, C₁-C₄, and D₁-D₄) are shown in FIG. 2A.

An example link utilization scenario, based on legacy approaches, is shown in FIG. 2A. In particular, shown in FIG. 2A is a link utilization scenario in which a request may be denied due to inefficient managing of link utilization in the overall topology. For example, the expander 122_{A}, which may have 4 links with each of the controllers 112₁ and 112₂, may utilize the four links to controller 112₁. A connection 210 may be established through the expander 122_{A} between the SD A₁ and the controller 112₁; a second connection 220 may be established through the expander 122_{A} between the SD A₂ and the controller 112₁; a third connection 230 may be established through the expander 122_{B} then expander 122_{A}, between the SD B₁ and the controller 112₁; and fourth connection 240 may be established through the expander 122_{B} then expander 122_{A}, between the SD B₂ and the controller 112₁, resulting in active connections being established over all available controller links between the expander 122_{A} and the controller 112₁.

Thus, at this point, all available (4) links between the expander 122_{A} and the controller 112₁ would be utilized, thus preventing establishment of any further connections into the controller 112₁ through the expander 122_{A}. Nonetheless, in legacy systems, the remaining expanders would not be made aware of such link unavailability. Therefore, any further attempts to establish connections to controller 112₁ through the expander 122_{A} would still require establishing connections in the topology 100 (unnecessarily) all the way to the expander 122_{A}, resulting in inefficient link utilization and, in some instances, in the inability to establish connections that should otherwise be available.

For example, after connections 210-240 are established, an attempt to establish connection 250 from the SD C₁ to the controller 112₁, may result in acquiring a path all the way to the expender 122_{A}—i.e., resulting in utilization of links (for establishing connections) between the expander 122_{C} and expander 122_{B}, and between the expander 122_{B} and expander 122_{A}, as shown in FIG. 2A. The expander 122_{A} may determine that there is no available links to the controller 110₁, sending the SD C₁ arbitration-in-progress (AIP) responses to connection requests received therefrom.

When a similar connection attempt is made to establish connection 260 from the SD C₄ to the controller 112₁, another path may be acquired all the way from the SD C₄ to the expender 122_{A}—i.e., causing establishment of connections and further utilization of links between the expander 122_{C} and expander 122_{B}, and between the expander 122_{B} and expander 122_{A} (which, the path, would be used in sending AIP response to the connections requests by the SD C₄). Thus, as a result, all (4) links between the expander 122_{B} and expander 122_{A} would be utilized, with two of these links being used merely to send back AIP responses. Such link utilization may prohibit further establishment of connections (particularly ones corresponding to connection requests with equal or lower priority) traversing the expander 122_{B} and expander 122_{A}, including connections that may otherwise be possible beyond expender 122_{A}. For example, with all four links between the expander 122_{B} and expander 122_{A} utilized (for connections 230, 240, 250, and 260), a connection request to establish connection 270, and subsequent input/output (TO) traffic, between the SD D₄ and the controller 112₂ would be blocked within the expender 122_{B} because all links between it and the expander 122_{A} are used up (including the two links therebetween, which may be utilized for partial paths from the SDs C₁ and C₄, which may correspond to connection requests having higher or equal priority), despite the availability of (all the) links between the expander 122_{A} and the controller 112₂.

An enhanced link utilization scheme, however, may mitigate prevention of connectivity by freeing links that are unnecessarily utilized for partial paths (i.e., links that are used in paths established for connections that fail to reach the intended target within the topology), such as by ensuring that these partial paths are terminated or blocked much sooner within the topology. An example of such enhanced link utilization corresponding to the scenario in the present figure is described in more detail in connection with FIG. 2B.

FIG. 2B illustrates an example use of a link utilization enhancement scheme in a Serial Attached SCSI (SAS) based networking topology. Referring to FIG. 2B, there is shown, again, the topology 100 of FIG. 1—particularly, the controllers 112₁ and 112₂, the expanders 122_{A}-122_{D}, and the SAS devices (the SDs) attached thereto.

An example of enhanced link utilization, in accordance with the present disclosure, is shown in FIG. 2B. In this regard, the example enhanced link utilization shown in FIG. 2B may correspond to the connection scenario of FIG. 2A. For example, as described with respect to FIG. 2A, all of the (4) links between expander 122_{A} and the controller 112₁ may be utilized—e.g., in establishing connections 210, 220, 230, and 240, between the controller 112₁ and each of SDs A₁, A₂, B₁, and B₂, respectively. Thus, at this point, because all available (4) links between the expander 122_{A} and the controller 112₁ are utilized, no further connections into the controller 112₁ through the expander 122_{A} may be possible. However, unlike in legacy implementations, in which components (e.g., expanders) in the topology are unaware of link unavailability within the topology, and would thus forward connection requests (i.e., continue setting up what would become partial paths) as long as they have available links to the next node(s) in the topology, in the enhanced scheme based on the present disclosure, the expanders may be configured to develop awareness of link availability (or unavailability) within the topology, including knowledge of link of unavailability in nodes upstream from the expanders. This awareness (or knowledge) may then be used to enable the termination of paths much earlier in the topology, thus freeing links that would otherwise be (unnecessarily) utilized.

Knowledge of link unavailability (and thus inability to setup requested connections) may be developed in the expanders based on, for example, messages (or processing thereof) that are typically sent when connection setups fail or are delayed. For example, with reference to the use scenario in topology 100 shown in FIG. 2B, after connections 210-240 are established, an attempt to establish connection 250 from the SD C₁ to the controller 112₁ (e.g., by the SD C₁ sending an OAF) may result in establishing a partial path all the way from the SD C₁ to the expander 122_{A}—e.g., the SD C₁ may send an equal/low priority OAF destined for the controller 112₁, which may traverse, within the topology 100, the expander 122_{C} to the expander 122_{B} and then to the expander 122_{A} (thus resulting in utilization of one of the available upstream links between the expander 122_{C} and the expander 122_{B}, and between the expander 122_{B} and the expander 122_{A}. The expander 122_{A} may then determine that there are no available links to the controller 110₁, and accordingly may respond (to the SD C₁) by sending arbitration-in-progress (AIP) responses to connection requests received therefrom, indicating that all the upstream links of the expander 122_{A} towards the controller 112₁ are occupied. In this regard, the arbitration-in-progress (AIP) responses may propagate through the partial path all the way from the expander 122_{A} to the SD C₁ (i.e., through the expander 122_{B} and the expander 122). In the enhanced scheme described herein, the expanders receiving the AIP responses may utilize these messages in generating and/or updating link utilization related information (e.g., local databases), which may be used in handling subsequent connection requests. For example, each of the expanders 122_{B} and 122_{C} may generate or update local link utilization related parameters (e.g., in a database), based on the AIPs responses, from the expander 122_{A}, to the OAF for attempted connection 250—e.g., to note that connectivity to the controller 112₁ via the expander 122_{A} is not possible due to utilization of all available links therebetween.

For example, the expander 122_{C} may maintain a local link utilization database (e.g., tracking all pending connection requests routed through it and/or previously received AIP responses), which may enable it to have knowledge of link unavailability with respect to a particular node in the topology (e.g., unavailability of links between the expander 122_{A} and the controller 112₁). Thus, when the expander 122_{C} receives new OAFs (having equal/lower priority) sent by the SD C₄ for example, requesting establishment of connection 260 to the controller 112₁, the expander 122_{C} may check its local link utilization database. When the pending connection (or AIP response corresponding thereto) of SD C₁ for the controller 112₁ (i.e. for connection 250) is found, the expander 122_{C} may not forward the OAF requests of SD C₄ on the available outgoing links to the next destination (i.e., to the expander 122_{B}). Rather, the expander 122_{C} may generate (locally) AIP responses and send them back to the SD C₄. In other words, the expander 122_{C} would only forward (to next nodes in the topology 100) the OAF request destined for the controller 112₁ only when there is no pending connection request for the controller 112₁ through it.

Similarly, the expander 122_{B} may maintain a link utilization database (e.g., tracking all pending connection requests routed through it and/or previously received AIP responses), which may enable it to have knowledge of link unavailability with respect to a particular node in the topology (e.g., unavailability of links between the expander 122_{A} and the controller 112₁. Thus, even if the new OAFs (having equal/lower priority) originating from the SD C₄ and requesting establishment of connection 260 to the controller 112₁ reach the expander 122_{B} (e.g., the expander 122C did not handle them directly, such as for failing to develop or use its link utilization data), the expander 122_{B} may still be able to do so. In this regard, the expander 122_{B} may check its own local link utilization database, and when the pending connection request (or AIP response corresponding thereto) of SD C₁ for the controller 112₁ (i.e. for connection 250) is found, the expander 122_{B} may not forward the OAF requests of SD C₄ on the available outgoing links to the next destination (i.e., to the expander 122_{A}). Rather, the expander 122_{B} may generate (its own) AIP responses and send them back to the SD C₄. In other words, the expander 122_{B} would only forward (to next nodes in the topology 100) the OAF request destined for the controller 112₁ only when there is no pending connection requests for the controller 112₁ through it.

As a result, the list link between the expander 122_{B} and the next node (the expander 122_{A}) would not be used (unnecessarily) for pending connection 260, and would remain available. Thus, when the SD D₄ sends requests for establishing connection 270 to the controller 112₂, the request may be completed successfully (using available links between the expander 122_{B} and the expander 122_{A}, then between the expander 122_{A} and the controller 112₂), and the SD D₄ may continue with its IO traffic. Accordingly, incorporating the ability to block pending connections earlier in the topology 100 (i.e., localize and/or shorten the partial paths of connection requests), would result in enhanced connection routing by the expanders, enhanced link utilization throughout the topology, and ultimately improve the IO throughput performance in the topology.

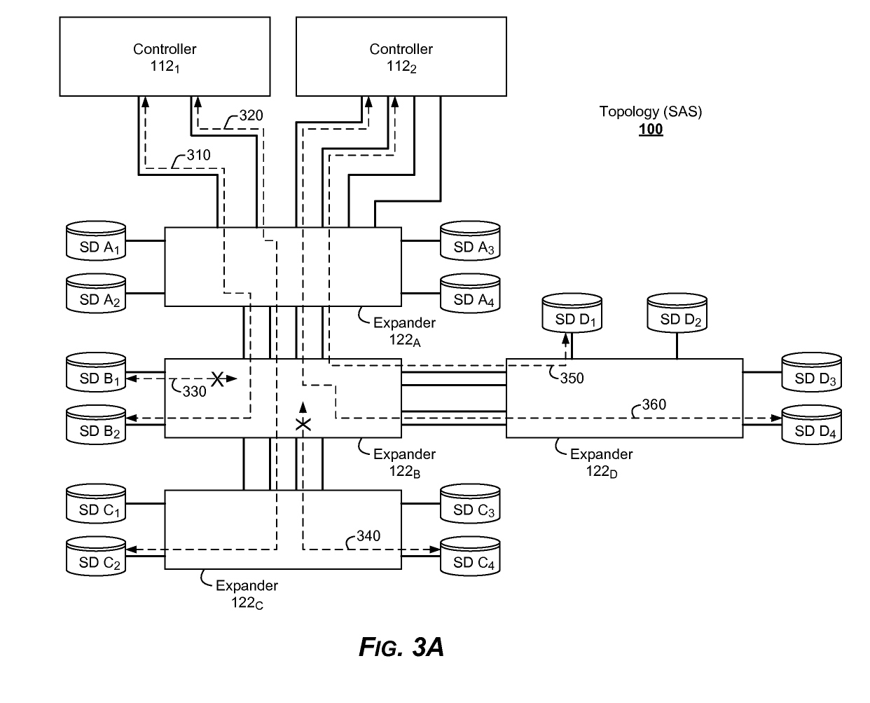

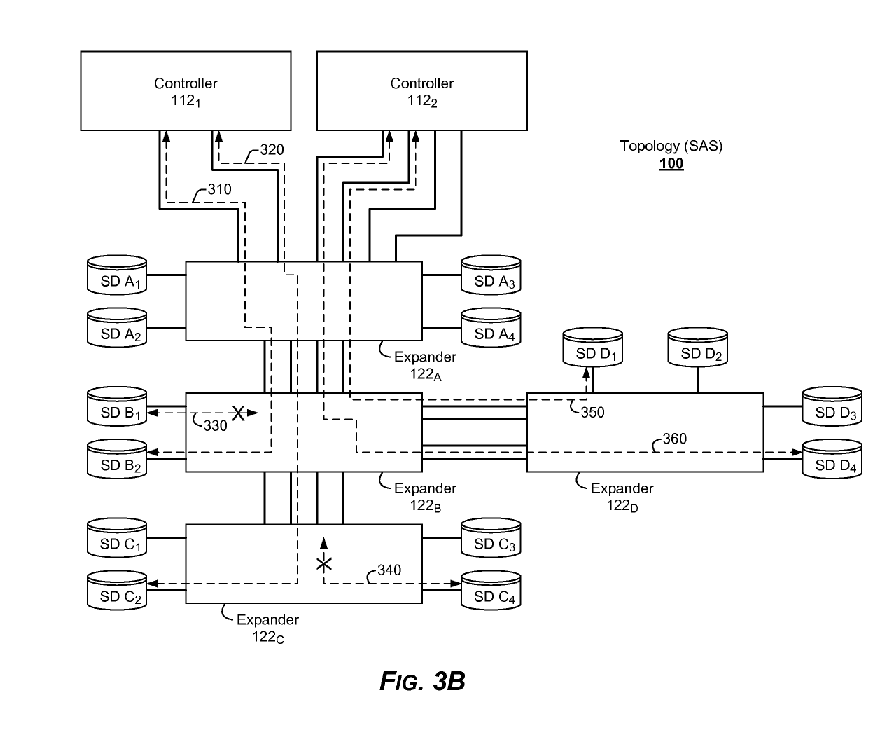

FIGS. 3A and 3B illustrate an example use of a link utilization enhancement scheme in a Serial Attached SCSI (SAS) based networking topology, based on sharing of link related data. Referring to FIGS. 3A and 3B, there is shown, again, the topology 100 of FIG. 1—particularly, the controllers 112₁ and 112₂, the expanders 122_{A}-122_{D}, and the SAS devices (the SDs) attached thereto.

In the example use scenarios shown in FIGS. 3A and 3B, nodes in the topology 100 may share link related information, which may be used (by other nodes) in assessing link availability/unavailability within the topology, and/or make determinations based therein regarding whether connectivity to particular target nodes are (not) possible. For example, each of the expanders 122_{A}, 122_{B}, 122_{C}, and 122_{D} may be configured to communicate (e.g., using unicast or broadcast messages) to other expanders in the topology 100 link related information. The information may comprise total number of links to other nodes, updates on utilized/freed links, and the like. For example, the expander 122_{A} may send to the expander 122_{B} a link related message indicating that it has two upstream links to the controller 112₁ and four upstream links to the controller 112₂. Thus, based on that message (i.e., the shared link information by the expander 122_{A}), the expander 122_{B} may determine after connections 310 and 320 are established from the SDs SD B₂ and C₂, respectively to the controller 112₁, through the expanders 122_{B} and 122_{A}, that there are no further links available to the controller 112₁ through the expander 122_{A}. Also expander 122_{B} while doing topology discovery (using SMP Message/Request), can create a link available table for all the devices including controller 112₁ and it can also maintain link utilized table for each device based on the active connection though the expander (for the device) and using these two table/info expander 122_{B} can find that number of link of the controller 122_{A} is already utilized. Accordingly, the expander 122_{B} may locally handle further OAFs targeted for the controller 112₁ (e.g., by directly sending AIP responses). Thus, as shown in FIG. 3A, when the expander 122_{B} receives OAF requests from the SD B₁ (for connection 330) and the SD C₄ (for connection 340), it may handle them directly, sending AIP responses back to both SDs. As a result, the two (other) upstream links from the expander 122_{B} to the expander 122_{A} would remain available (rather than being used unnecessarily for partial paths for connections 330 and 340, all the way to the expander 122_{A}), and as such connections 350 and 360 subsequently may be setup successfully from the SDs D₁ and D₄ to the controller 112₂, through the expanders 122_{B} and 122_{A}.

The broader the scope of information sharing is, the more that handling can be localized, thus resulting in more enhanced link utilization. For example, if the link related message from the expander 122_{A} was broadcast within the topology, thus reaching the expander 122_{C}, some requests may be handled even earlier in the topology. Thus, based on that message, the expander 122_{C} may update its link database to indicate that the expander 122_{A} has only two links to the controller 112₁. Accordingly, when subsequent messages are received indicating that both of these are used (e.g., being broadcast by the expander 122_{A} and/or the expander 122_{B}, after connections 310 and 320 are setup), the expander 122_{C} may directly handle subsequent requests for connections to the controller 112₁ through the expander 122_{A}—e.g., as shown in FIG. 3B, the expander 122_{C} may directly handle the OAF requests received from the SD C₄ (for connection 340), such as by generating and sending back directly AIP responses.

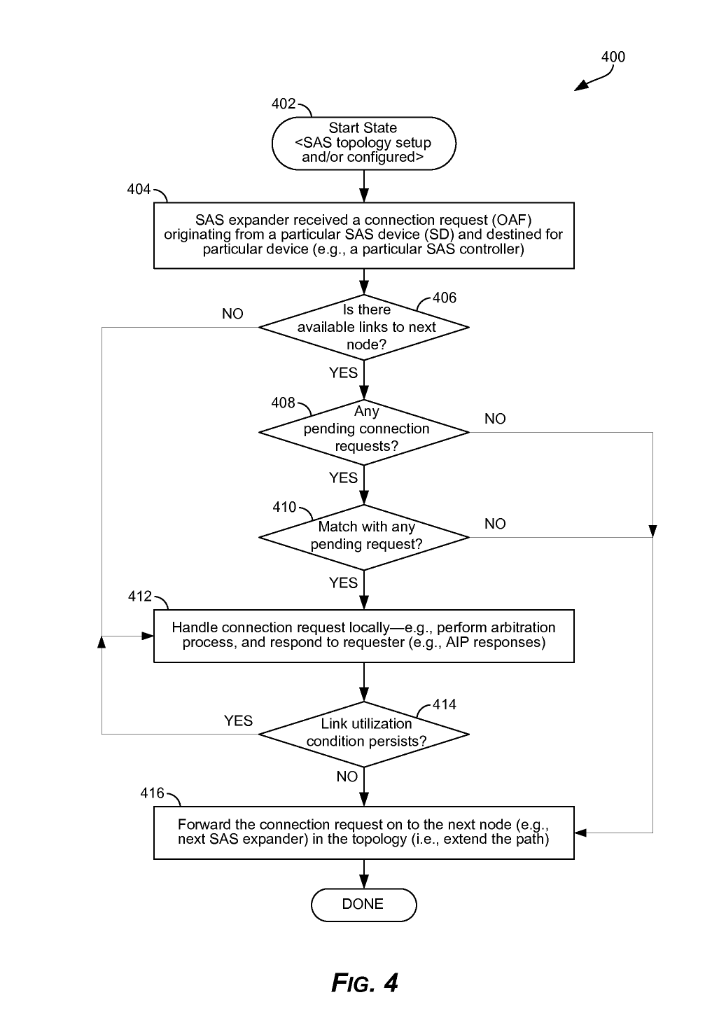

FIG. 4 is a flowchart illustrating an example process for handling connection requests in a SAS topology incorporating use of enhanced link utilization. Referring to FIG. 4, there is shown a flow chart 400, comprising a plurality of example steps.

In a starting step 402, a SAS topology (e.g., the SAS topology 100) may be setup and/or configured. For example, the SAS topology may be setup using a plurality of network devices, which may be configured to run or perform various functions, including SAS expanders, SAS controllers, and SAS devices (SDs).

In step 404, a SAS expander (e.g., the SAS expander 122_{B} in the topology 100) may receive a connection request (e.g., in the form of OAF), which may originate from a particular SAS device, and may be destined for particular target device (e.g., particular SAS controller, such as the SAS controller 112₂ in the topology 100).

In step 406, the SAS expander may determine if it has any available links to the next node in the topology that would need to be traversed to reach the specified destination. If no available links are available, the process may jump to step 412; otherwise, the process may proceed to step 408.

In step 408, the SAS expander may determine whether there are any pending connection requests through that SAS expander. If there are no other connection requests currently pending in the SAS expander, the process may jump to step 416; otherwise, the process may proceed to step 410.

In step 410, the SAS expander may determine whether the received connection request matches any of the currently pending connection requests. For example, the SAS expander may compare the received OAF with the pending connection requests. In this regard, the SAS expander may compare, for example, the destination SAS address in the received OAF with destination SAS addressees of all currently pending connection requests.

A successful match may be made based on particular criteria—e.g., if the destination SAS address of a pending connection request matches with the destination SAS address in the received OAF, the pending connection request has higher priority, and the SAS expander is currently receiving AIP responses for that pending connection request. If there are no successful matches with any of the currently pending connection requests in the SAS expander, the process may jump to step 416; otherwise, the process may proceed to step 412. While the checks performed in steps 408 and 410 are described herein as being based on pending (other) connection requests, the process is not so limited, and other parameters (and checks based thereon) may be used in lieu of (or in addition to) these checks to ascertain link utilization in the topology (including in other nodes upstream for the current nodes). This may include, for example, checks based on link utilization data as obtained from update messages communicated (as unicast or broadcast messages) to the present node.

In step 412, the SAS expander would not forward the received OAF to the destination (even if there are available links to the next node in the topology). Rather, the SAS expander may locally handle the received OAF. For example, the SAS expander may perform an arbitration process, and may generate and forward (send back) AIP responses (on the incoming link of the received OAF) to the originator. The SAS expander may continue to do so for as long as the condition—i.e., reception of AIP responses for the matched pending connection request(s)—persists, such as by continually checking (in step 414) the link utilization in the topology (e.g., re-check pending connection requests, updates from other nodes, etc.). When the condition is resolved, the process may proceed to step 416.

In step 416, the OAF request may be forwarded to the next node (e.g., next SAS expander, such as the SAS expander 122_{A} in the topology 100), thus extending the path.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for enhancing active link utilization for SAS topology.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein. Another typical implementation may comprise an application specific integrated circuit or chip.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form. Accordingly, some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A method, comprising:
in a network device that is configured to provide an expander function within a serial attached SCSI (SAS) topology:
monitoring link utilization within the SAS topology, wherein the monitoring comprises determining availability of links for at least one node within the SAS topology with respect to other nodes in the SAS topology; and
managing connection requests received by the expander function based on the monitoring of link utilization, wherein the managing comprises determining for each received connection request when link unavailability in the other nodes within the SAS topology prevents connectivity to a destination node corresponding to the connection request.

2. The method of claim 1, comprising handling the connection request directly by the expander function in the network device based on the determining that the connectivity to the particular destination node is prevented.

3. The method of claim 2, comprising issuing by the expander function messages indicating that the connectivity to the particular destination node is prevented.

4. The method of claim 1, comprising determining availability of links within the SAS topology based on messages received from the other nodes in the SAS topology.

5. The method of claim 4, wherein the messages received from the other nodes in the SAS topology are responsive to connections requests.

6. The method of claim 5, wherein the messages comprise arbitration-in-progress (AIP) responses.

7. The method of claim 1, comprising generating and/or maintaining a link availability database by the expander function in the network device, for use in tracking link availability within the SAS topology.

8. The method of claim 7, comprising updating the link availability database based on data received from the other nodes in the SAS topology.

9. The method of claim 1, comprising communicating link availability related updates to the other nodes in the SAS topology.

10. The method of claim 9, comprising communicating the link availability related updates to the other nodes in the SAS topology based on reception, by the expander function, of messages or information that are indicative of link availability or changes thereto.

11. A system, comprising:
one or more circuits for use in a network device that is configured to provide an expander function within a serial attached SCSI (SAS) topology, the one or more circuits being operable to:
monitor link utilization within the SAS topology, wherein the monitoring comprises determining availability of links for at least one node within the SAS topology with respect to other nodes in the SAS topology; and
manage connection requests received by the expander function based on the monitoring of link utilization, wherein the managing comprises determining for each received connection request when link unavailability in the other nodes within the SAS topology prevents connectivity to a destination node corresponding to the connection request.

12. The system of claim 11, wherein the one or more circuits are operable to handle the connection request directly by the expander function in the network device based on the determining that the connectivity to the particular destination node is prevented.

13. The system of claim 12, wherein the one or more circuits are operable to issue by the expander function messages indicating that the connectivity to the particular destination node is prevented.

14. The system of claim 11, wherein the one or more circuits are operable to determine availability of links within the SAS topology based on messages received from the other nodes in the SAS topology.

15. The system of claim 14, wherein the messages received from the other nodes in the SAS topology are responsive to connections requests.

16. The system of claim 15, wherein the messages comprise arbitration-in-progress (AIP) responses.

17. The system of claim 11, wherein the one or more circuits are operable to generate and/or maintain a link availability database by the expander function in the network device, for use in tracking link availability within the SAS topology.

18. The system of claim 17, wherein the one or more circuits are operable to update the link availability database based on data received from the other nodes in the SAS topology.

19. The system of claim 11, wherein the one or more circuits are operable to communicate link availability related updates to the other nodes in the SAS topology.

20. The system of claim 19, wherein the one or more circuits are operable to communicate the link availability related updates to the other nodes in the SAS topology based on reception, by the expander function, of messages or information that are indicative of link availability or changes thereto.
